(19) United States
(12) Patent Application Publication
(10) Pub. No.: US 2005/0097677 A1
(43) Pub. Date: May 12, 2005

(54) Tool set for disassembling car audio devices

(76) Inventor: Hsin Fa Kang, Tainan City (TW)

Correspondence Address: Hsin Fa Kang, P.O. Box 90, Tainan City, 704, TW

(21) Appl. No.: 10/701,517

(22) Filed: Nov. 6, 2003

(51) Int. Cl. B25B 13/00

(52) U.S. Cl. 7/138

(57) ABSTRACT

A tool set for disassembling car audio devices has two handles and two tool assemblies, wherein each of the two handles has a chamber capable of being pivoted with each of the two tool assemblies therein, and each of the two tool assemblies is composed of a plurality of tool members of different types, by which the tool set of the present invention is convenient in carrying by having the tool members of different types pivoted and stored together in the two handles, and is easy in operation only by holding the two handles to employ the tool members to disassemble car audio devices from vehicles quickly.

### BACKGROUND OF THE INVENTION

1. Field of the Invention

This invention relates to a tool set for disassembling car audio devices, particularly to one having two handles and two tool assemblies, wherein each of the two handles has a chamber capable of being pivoted with each of the two tool assemblies therein, and each of the two tool assemblies is composed of a plurality of tool members of different types, by which the tool set of the present invention is convenient in carrying by having the tool members of different types pivoted and stored together in the two handles, and is easy in operation only by holding the two handles to employ the tool members to disassemble car audio devices from vehicles quickly.

2. Description of the Prior Art

Generally speaking, as shown in FIG. 1, a known conventional disassembling tool mainly has a pair of tool members 1 designed with an identical shape. Each of the pair of tool members 1 has an insertion end 10 disposed at one end thereof and a grip 11 disposed at the other end thereof. Each of the two grips 11 is provided with a through hole 12 disposed therein. In using, firstly a user needs to extend his fingers of both hands respectively into the two through holes 12 of the two grips 11, and then hold the two grips 11 firmly. Secondly, insert the two insertion ends 10 of the pair of tool members 1 into a gap between a car audio device and an audio mounting hole disposed on a dashboard of a vehicle to make the car audio device disengaged from the audio mounting hole.

Since there are different engaging structures for car audio devices and audio mounting holes of various vehicles, it is necessary for users to prepare many types of tool members for needs of various vehicles at any time. However, such numerous tool members generally placed separately are very troublesome in carry and liable to be lost. Moreover, it is very inconvenient to take proper tool members among so many tool members in a short time for prompt use.

### SUMMARY OF THE INVENTION

The main purpose of the present invention is to provide a tool set for disassembling car audio devices, convenient in carrying and operation.

The main feature of the invention is to provide a tool set for disassembling car audio devices mainly including:

two handles capable of being disposed opposite to each other, each of the two handles having a chamber disposed therein and two sidewalls respectively and oppositely disposed at both sides thereof, each of the two sidewalls having an axle hole disposed thereon and at least one elastic retaining piece disposed thereon, the two axle holes disposed opposite to each other and capable of being passed through by a pivot axle; and, two tool assemblies capable of being respectively pivoted in the two chambers of the two handles, each of the two tool assemblies composed of a plurality of tool members of different types, wherein one of the plurality of tool members is in a U-shape and provided with a bent part, and the rest of the plurality of tool members each has a pivoting part disposed at one end thereof and provided with a through hole.

### BRIEF DESCRIPTION OF DRAWINGS

This invention will be better understood by referring to the accompanying drawings, wherein:

FIG. 1 is a perspective view showing a pair of known conventional disassembling tool members;

FIG. 2 is an exploded perspective view of a tool set for disassembling car audio devices in the present invention;

FIG. 3 is a perspective view of the tool set for disassembling car audio devices in the present invention; and, FIG. 4 is a schematic view of the tool set for disassembling car audio devices in the present invention in use.

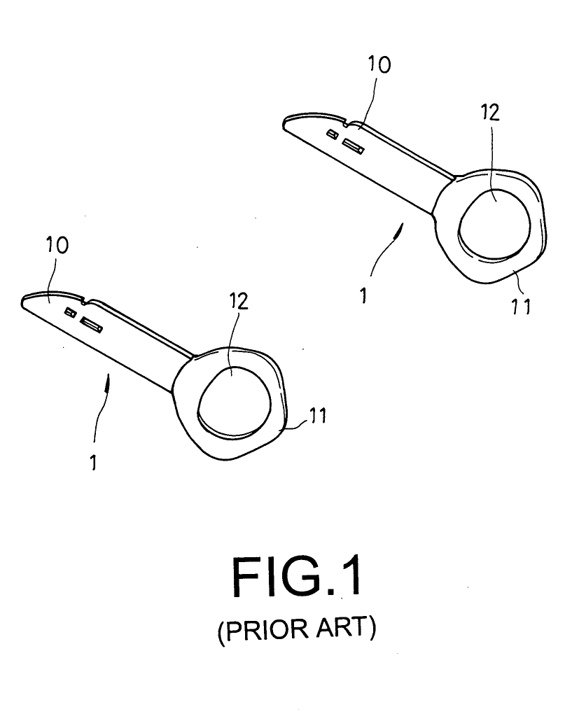

### DETAILED DESCRIPTION OF THE PREFERRED EMBODIMENT

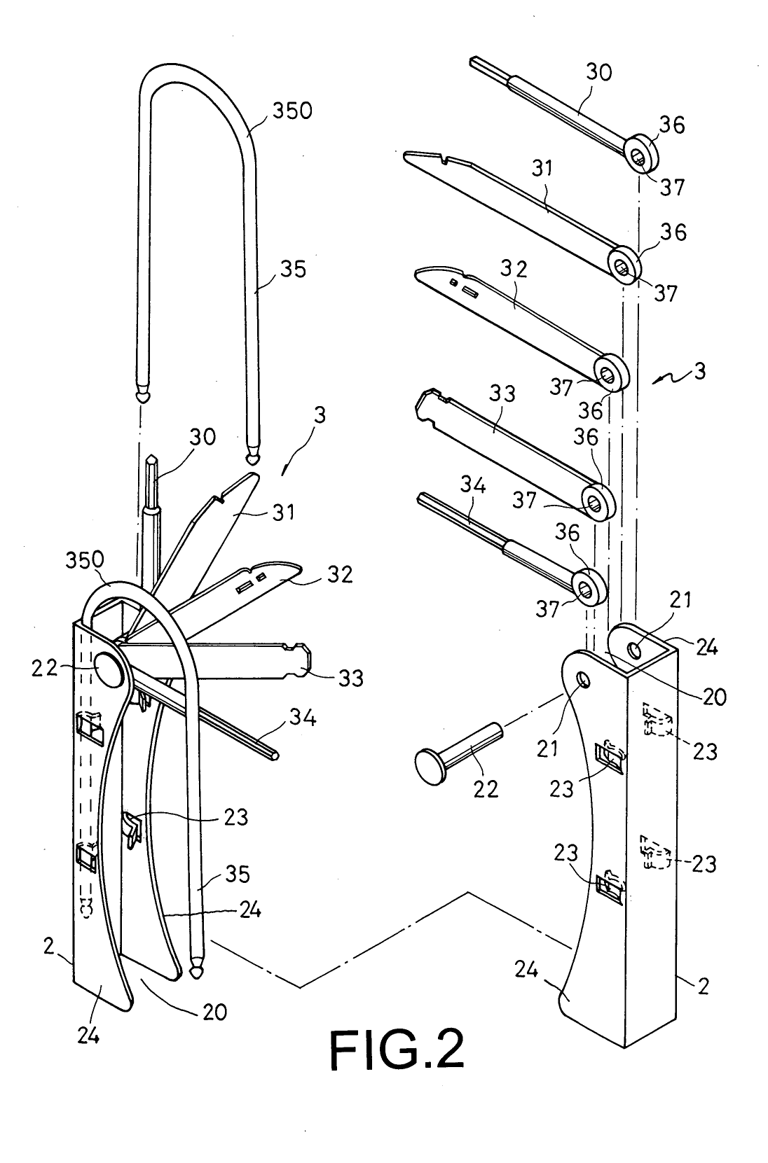

A preferred embodiment of a tool set for disassembling car audio devices in the present invention, as shown in FIG. 2, mainly includes two handles 2 and two tool assemblies 3.

The two handles 2 are capable of being disposed opposite to each other and each of which has a chamber 20 disposed therein and two sidewalls 24 respectively and oppositely disposed at both sides thereof. Each of the two sidewalls 24 has an axle hole 21 disposed proximate one end thereof and two elastic retaining pieces 23 disposed on an inner wall surface thereof. The two axle holes 21 of the two sidewalls 24 are disposed opposite to each other and capable of being passed through by a pivot axle 22. The two elastic retaining pieces 23 of the two sidewalls 24 are disposed opposite to each other.

The two tool assemblies 3 are capable of being respectively pivoted in the two chambers 20 of the two handles 2. Each of the two tool assemblies 3 is composed of a plurality of tool members 30, 31, 32, 33, 34 and 35 with different types applied for various vehicles, such as the tool member 30 applied for BMW vehicles, the tool member 31 applied for Mercedes-Benz vehicles, the tool member 32 applied for Beetle and Audi vehicles, the tool member 33 applied for VW vehicles, the tool member 34 applied for BMW vehicles, and the tool member 35 applied for Ford, VW, Audi vehicles. Among the tool members 30, 31, 32, 33, 34 and 35 of each of the two tool assemblies, the tool member 35 is designed in a U-shape and provided with a bent part 350, and the rest of the tool members 30, 31, 32, 33 and 34 each has a pivoting part 36 disposed at one end thereof and provided with a through hole 37.

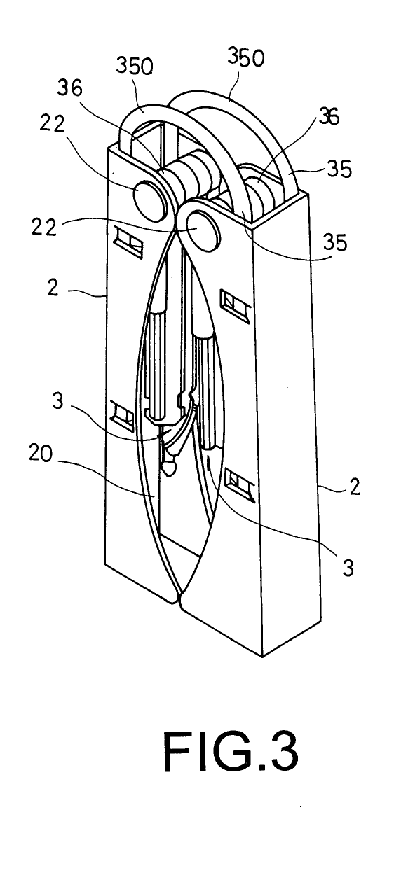

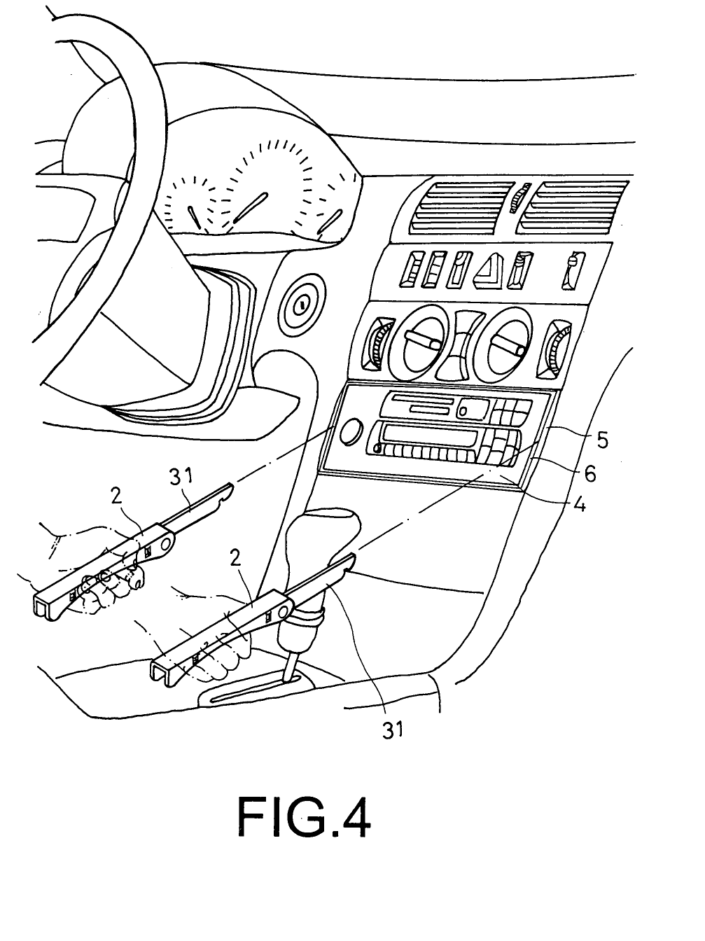

In assembling, referring to FIGS. 2 and 3, firstly a user may make the through holes 37 of the pivoting parts 36 of the tool members 30, 31, 32, 33 and 34 of each of the two tool assemblies 3 aligned with each other, and then place all the through holes 37 of the tool members 30, 31, 32, 33 and 34 into the chamber 20 of each of the two handles 2 with all the through holes 37 of the tool members 30, 31, 32, 33 and 34 aligned to the two opposite axle holes 21 of each of the two handles 2. Secondly, pass the pivot axle 22 through the two opposite axle holes 21 and all the through holes 37 of the tool members 30, 31, 32, 33 and 34, and then make both ends of the pivot axle 22 riveted on the handle 2, by which one ends of the tool members 30, 31, 32, 33 and 34 are capable of being pivoted together in the chamber 20 of the handle 2. Thirdly, make the two handles 2 that have respectively been pivoted with the tool members 30, 31, 32, 33 and 34 of the two tool assemblies 3 abutted against each other. Finally, make both sides of all the two U-shaped tool members 35 respectively passing through and firmly engaged by the elastic retaining pieces 23 disposed on the inner wall surfaces of the two sidewalls 24 of the two handles 2 with the bent parts 350 of the two U-shaped tool members 35 protruded at one sides of the two handles 2 so as to make the two handles 2 joined together, by which an assemblage of the tool set for disassembling car audio devices in the present invention is completed easily and quickly. Moreover, the two bent parts 350 of the two U-shaped tool members 35 are capable of being used as hooks so that the tool set of the present invention can be hooked on a wall surface or in a tool case, convenient for storage.

In using, referring to FIGS. 3 and 4, when a user is to disassemble a car audio device 4 from a vehicle, firstly draw the two U-shaped tool members 35 provided with the two bent parts 350 out of the elastic retaining pieces 23 of the two handles 2 so as to make the two handles becoming separated. Secondly, according to the type of a required vehicle, select a pair of proper tool members among the tool members 30, 31, 32, 33 and 34 of the two tool assemblies 3 (e.g. the tool members 31), and then rotate the selected tool members respectively out of the chambers 20 of the two handles 2. Finally, hold the two handles 2 with both hands, and then insert free ends of the selected tool members into a gap 6 between the car audio device 4 and an audio mounting hole 5 disposed on a dashboard of the vehicle to make the car audio device 4 disengaged from the audio mounting hole 5, by which the car audio device 4 can be quickly removed from the audio mounting hole 5 so as to complete the disassembling work, very convenient in operation. Moreover, the design of the two handles 2 not only allows the user to hold the two handles 2 firmly and comfortably in use, but also allows many types of tool members applied for disassembling car audio devices 4 of various vehicles to be stored together in the two handles 2, very convenient in carrying without worry of being lost.

While the preferred embodiment of the invention has been described above, it will be recognized and understood that various modifications may be made therein and the appended claims are intended to cover all such modifications that may fall within the spirit and scope of the invention.

1. A tool set for disassembling car audio devices comprising:
two handles capable of being disposed opposite to each other, and each of said two handles having a chamber disposed therein and two sidewalls respectively and oppositely disposed at both sides thereof, each of said two sidewalls having an axle hole disposed thereon and at least one elastic retaining piece disposed thereon, said two axle holes disposed opposite to each other and capable of being passed through by a pivot axle;
two tool assemblies capable of being respectively pivoted in said two chambers of said two handles, each of said two tool assemblies composed of a plurality of tool members of different types, wherein one of said plurality of tool members is in a U-shape and provided with a bent part, and the rest of said plurality of tool members each has a pivoting part disposed at one end thereof and provided with a through hole; and,
whereby said tool set is convenient in carrying by having said two pluralities of tool members of different types pivoted and stored together in said two handles and further having said two U-shaped tool members passing through and engaged by said elastic retaining pieces of said two handles so as to make said two handles abutted against each other and joined together; and said tool set is easy in operation only by holding said two handles to employ said tool members to disassemble car audio devices from vehicles quickly.
